(19) United States
(12) Patent Application Publication
(10) Pub. No.: US 2007/0153528 A1
(43) Pub. Date: Jul. 5, 2007

(54) FRONT PANEL OF COMPUTER SYSTEM WITH LIGHT-REFLECTING MEMBER

(75) Inventors: YUN-LUNG CHEN, TU CHENG (TW); Yu-Ming Xiao, Shenzhen (CN); Xian-Huang Gao, Shenzhen (CN); Jian Hu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,818

(22) Filed: May 11, 2006

(30) Foreign Application Priority Data
Dec. 30, 2005 (CN) 200520121450.2

(51) Int. Cl. F21V 7/00

(52) U.S. Cl. 362/341

(57) ABSTRACT

A panel assembly includes a front panel (10), and a light-reflecting member (40) attached to the front panel. A light-pervious mechanism (144) is disposed on the front panel. The light-reflecting member has a hollow body. A light source (30) is accommodated in the hollow body. A through opening (48) is defined in the hollow body for coupling with the light-pervious mechanism of the front panel. Some rays of the light source are reflected by the light-reflecting member, and shine on the light-pervious mechanism through the through opening.

### FIELD OF THE INVENTION

The present invention relates to front panels of computer systems, and more particularly to a front panel of a computer system with a light-reflecting member.

### DESCRIPTION OF RELATED ART

Usually, a light source, such as a light-emitting diode, is installed on a front panel of a conventional computer system, in order to display the working state of the computer system.

A light-pervious switch button is positioned on the front panel. A post is disposed on the switch button, corresponding to a switch controlling a power supply of the light source. When the post of the switch button is pushed to press the switch, the power supply switches on and the light source emits light, and the switch button is illuminated.

However, in conventional computer system, one light source is used for one corresponding switch button. If another switch button or other light-pervious member needs illumination, another light-emitting diode should be provided.

What is needed, therefore, is a front panel of a computer system with a light-reflecting member which needs only one light source to light up more than one light-pervious member at the same time.

### SUMMARY OF INVENTION

A panel assembly of a computer system includes a front panel, and a light-reflecting member attached to the front panel. A light-pervious mechanism is disposed on the front panel. The light-reflecting member has a hollow body. A light source is accommodated in the hollow body. A through opening is defined in the hollow body for coupling with the light-pervious mechanism of the front panel. Some rays of the light source are reflected by the light-reflecting member, and shine on the light-pervious mechanism through the through opening.

Other advantages and novel features will be drawn from the following detailed description of preferred embodiments with attached drawings, in which:

### BRIEF DESCRIPTION OF DRAWINGS

FIG. 1 is an isometric cutaway view of a front panel, the front panel including a light source and a light-reflecting member;

FIG. 2 is an enlarged, isometric view of the light-reflecting member of FIG. 1; and

FIG. 3 is an assembled view of FIG. 1.

### DETAILED DESCRIPTION

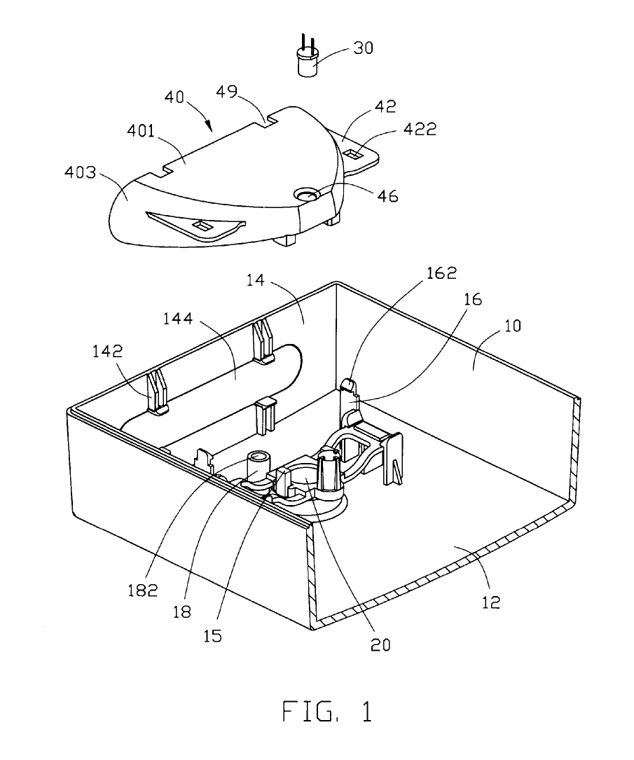

Referring to FIG. 1, a front panel 10 of an electronic device like a computer includes a base 12, and a bent plate 14 generally perpendicular to the base 12. A light-pervious button 20 is disposed on an inner surface of the base 12, and exposed outside the base 12. The button 20 is illuminated when a light source is on. Two projecting blocks 15 are respectively formed at opposite sides of the button 20. A pair of elongated hooks 16 is formed on the base 12 adjacent the button 20 between the bent plate 14 and the button 20. Each elongated hook 16 has a hook protrusion 162 at a free end thereof. A positioning post 18 with a positioning hole 182 protrudes from the base 12 in a middle between the pair of elongated hooks 16. A pair of parallel guiding protrusions 142, each with a slot defined therein, is formed on an inner surface of the bent plate 14, and extends along a direction perpendicular to the base 12. A generally ellipse-shaped through opening is defined in the bent plate 14, and extends along a direction perpendicular to the guiding protrusions 142. A light-pervious mechanism, such as a generally ellipse-shaped transparent board 144, is fitted into the through opening by engaging with the slots of the guiding protrusions 142.

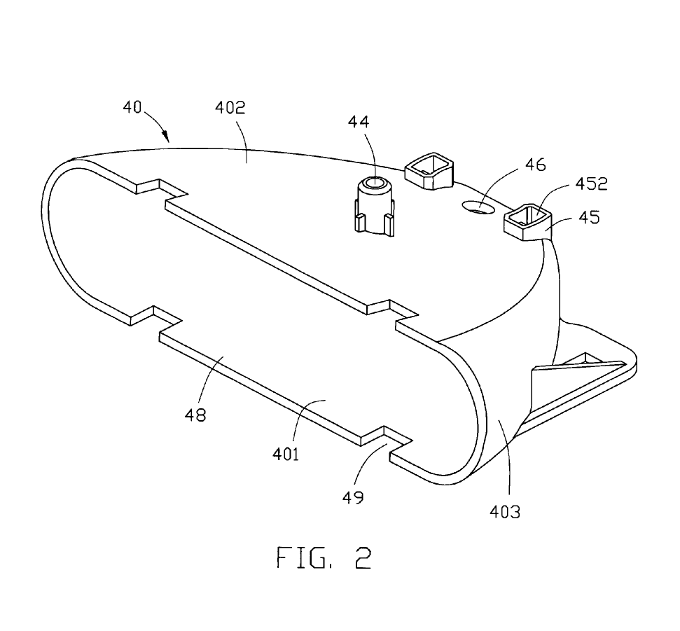

Referring to FIGS. 1 and 2, a light guide member like a light-reflecting member 40 is configured to be disposed on an inner surface of the front panel 10, for reflecting rays of a light source 30. The light source 30 may, for example, be a light-emitting diode. The light-reflecting member 40 has a hollow body, and includes a top wall 401, a bottom wall 402 parallel to the top wall 401, and a generally parabola-shaped sidewall 403. A pair of extending clips 42 protrudes from the sidewall 403 at opposite sides respectively. Each extending clip 42 defines a locking hole 422 therein, for receiving the corresponding hook protrusion 162 of the elongated hook 16 of the base 12. A mounting post 44 protrudes down from the bottom wall 402 of the light-reflecting member 40, for engaging into the positioning hole 182 of the positioning post 18 of the front panel 10. A pair of securing portions 45 is formed at the bottom wall 402 of the light-reflecting member 40, and each securing portion 45 defines a securing slot 452 therein, for receiving the corresponding projecting block 15. A through hole 46 is defined in a rear end of the light-reflecting member 40, between the securing portions 45, through the top wall 401 and the bottom wall 402 thereof, for accommodating the light source 30. A generally ellipse-shaped through opening 48 is defined in a front end of the light-reflecting member 40, surrounded by adjacent edges of the top wall 401, the bottom wall 402, and the sidewall 403. A plurality of cutouts 49 is defined in opposite edges of the light-reflecting member 40, for accommodating the guiding protrusions 142 of the front panel 10.

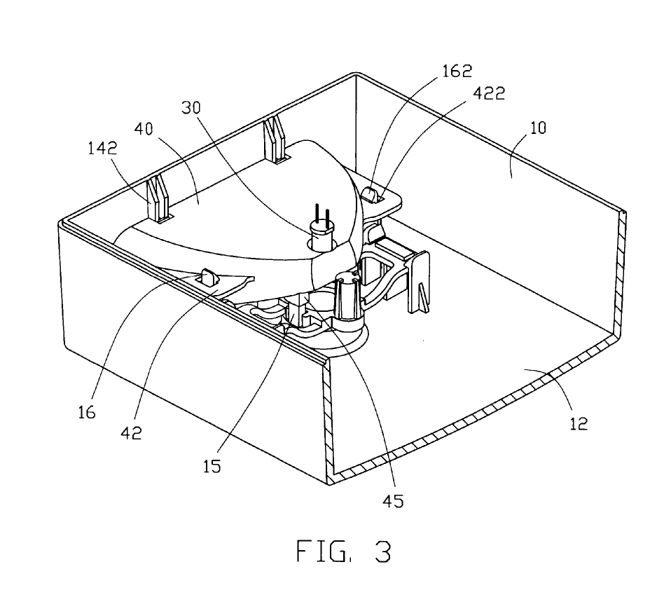

Referring also to FIG. 3, in assembly, the guiding protrusions 142 of the bent plate 14 of the front panel 10 are inserted into the corresponding cutouts 49 of the light-reflecting member 40 respectively. The through opening 48 of the light-reflecting member 40 is adjacent to the transparent board 144. Then the light-reflecting member 40 is pushed toward the base 12, until the mounting post 44 and the projecting blocks 15 are inserted into the positioning holes 182 of the positioning posts 18 and the securing slots 452 of the securing portions 45 respectively. The hook protrusions 162 of the elongated hooks 16 are inserted through the locking holes 422 of the extending clips 42, and engage with the extending clips 42 respectively. The light-reflecting member 40 is thus secured on the front panel 10. The through hole 46 aligns with the button 20, and the through opening 48 is opposite to the transparent board 144. The light source 30 is then positioned into the through hole 46, and electrically connects with the computer system for receiving power.

In use, the button 20 is pushed to start the computer system. The light source 30 emits light. Some rays of the light source 30 shine on the button 20 through the through hole 46, and some rays directly irradiate the transparent board 144, and other rays are reflected onto the transparent board 144 by an inner surface of the light-reflecting member 40. Thus, the button 20 and the transparent board 144 are illuminated, thereby showing a beautiful effect on the front panel 10 when the computer system at work.

In this embodiment, the light-pervious mechanism may include a plurality of holes defined in the bent plate 14 of the front panel 10 or the transparent board 144.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A panel assembly comprising:
a front panel with a light source;
a button attached to the front panel, the button being illuminated when receiving rays of the light source;
a light-pervious mechanism disposed on the front panel; and
a light-reflecting member attached to the front panel, for reflecting some rays of the light source onto the light-pervious mechanism.

2. The panel assembly as described in claim 1, wherein the light-pervious mechanism comprises a transparent board attached to the front panel.

3. The panel assembly as described in claim 1, wherein the light-pervious mechanism comprises a plurality of holes defined in the front panel.

4. The panel assembly as described in claim 1, wherein the light-reflecting member has a hollow body, and defines a through opening therein, for the rays of the light source irradiating on the light-pervious mechanism.

5. The panel assembly as described in claim 1, wherein the light-reflecting member defines a through hole therein, for receiving the light source and the rays of the light source irradiating on the button.

6. The panel assembly as described in claim 1, wherein the front panel comprises a base and a bent plate generally perpendicular to the base, the light-pervious mechanism is disposed on the bent plate, and the button is disposed on the base.

7. The panel assembly as described in claim 6, wherein at least one guiding protrusion is formed on the bent plate along a direction perpendicular to the base, and at least one cutout is defined in the light-reflecting member for receiving the at least one guiding protrusion.

8. The panel assembly as described in claim 7, wherein the light-pervious mechanism extends along a direction perpendicular to the at least one guiding protrusion.

9. The panel assembly as described in claim 6, wherein a pair of hooks is formed on the base of the front panel, and a pair of extending clips is formed on the light-reflecting member, each extending clip defines a locking hole therein for receiving the corresponding hook therein.

10. The panel assembly as described in claim 6, wherein a positioning post with a positioning hole is formed on the base of the front panel, and a mounting post is formed on the light-reflecting member for engaging into the positioning hole.

11. The panel assembly as described in claim 4, wherein the light-reflecting member comprises a top wall, a bottom wall parallel to the top wall, and a generally parabola-shaped sidewall, and the through opening is surrounded by adjacent edges of the top wall, the bottom wall, and the sidewall.

12. A panel assembly comprising:
a front panel with a light-pervious mechanism disposed thereon; and
a light-reflecting member attached to the front panel having a hollow body, a light source accommodated in the hollow body, a through opening defined in the hollow body for coupling with the light-pervious mechanism of the front panel, wherein some rays of the light source are reflected by the light-reflecting member and shine on the light-pervious mechanism through the through opening.

13. The panel assembly as described in claim 12, wherein the light-pervious mechanism comprises a transparent board attached to the front panel.

14. The panel assembly as described in claim 12, wherein a button is disposed on the front panel, and the light-reflecting member defines a through hole therein for receiving the light source, some of the rays of the light source irradiating on the button through the through hole.

15. The panel assembly as described in claim 12, wherein the front panel comprises a base and a bent plate generally perpendicular to the base, the light-pervious mechanism is disposed on the bent plate, and the button is disposed on the base.

16. The panel assembly as described in claim 15, wherein at least one guiding protrusion is formed on the bent plate along a direction generally perpendicular to the base, and at least one cutout is defined in the light-reflecting member for receiving the at least one guiding protrusion.

17. The panel assembly as described in claim 16, wherein the light-pervious mechanism extends along a direction perpendicular to the at least one guiding protrusion.

18. An electronic device comprising:
a panel of said electronic device installably extending along a side of said electronic device;
an operable button movably installable to said panel and exposable to an outside of said electronic device so as to be user-operable through an occupied area of said button defined on said panel;
a light source installable beside said button inside said electronic device so as to illuminate said button based on user operation on said button; and
a light guide member installable between said light source and another area of said panel other than said occupied area of said button on said panel in order to guide light from said light source toward said another area for illumination thereof.

19. The electronic device as described in claim 18, wherein said another area of said panel forms a light-pervious mechanism so as to transmit said light of said light source to said outside of said electronic device.

20. The electronic device as described in claim 18, wherein said light guide member comprises a hollow body having light reflective inner walls.
